(19) United States
(12) Patent Application Publication
(10) Pub. No.: US 2023/0314057 A1
(43) Pub. Date: Oct. 5, 2023

(54) TRANSPORT CRATE FOR FOODSTUFFS

(71) Applicant: Giulio DE CASTRO BOZANO, Rio De Janeiro (BR)

(72) Inventor: Giulio DE CASTRO BOZANO, Rio De Janeiro (BR)

(21) Appl. No.: 18/023,560

(22) PCT Filed: Dec. 18, 2020
(86) PCT No.: PCT/BR2020/050569

§ 371 Date: Feb. 27, 2023

(30) Foreign Application Priority Data
Nov. 24, 2020 (BR) BR1020200239163

(51) Int. Cl. F25D 11/00; A47J 47/14

(52) U.S. Cl. CPC F25D 11/003; A47J 47/145; F25B 2321/0212

(57) ABSTRACT

The present invention discloses a transport crate (100) used to transport foodstuffs that supports a controlled temperature and contains thermally independent heated or cooled compartments that keep the transported foodstuffs protected and at the correct temperature.

### FIELD OF THE INVENTION

The present invention relates to a transport crate for transporting foodstuffs, which can cause the temperature inside the crate to be maintained, either for heating or cooling, so as to maintain the temperature of the foodstuff during transportation.

### BACKGROUND ART

The use of food delivery services, in recent years, is no longer a sporadic practice and has become part of the daily routine of many people. Currently, especially in big cities, it is possible to have access to any product at any time of the day thanks to delivery services. Particularly in the food sector, there has been a significant increase in demand for food delivery services.

In general, a fundamental requirement for a customer to choose a particular restaurant is the quality of the foodstuff offered. Although taking care of meal preparation is an essential factor to ensure foodstuff quality and customer satisfaction, handling and transporting foodstuffs after preparation is also a factor that contributes significantly to product quality. These factors were motivators for the present invention, which proposes a transport crate, capable of maintaining the temperature inside the crate, thus ensuring the integrity and quality of the foodstuff to be transported.

In this context, a plurality of transport crate for transporting foodstuffs are known in the prior art. An example is patent document CN208108461, which discloses a device for transporting hot and cold food products, that uses a temperature sensor to detect the need for heating and cooling.

The patent document U.S. Pat. No. 6,135,273 discloses a device for transporting hot and cold food products. However, this document focuses on providing a substantially dry environment and the device does not rely on thermal elements to maintain the internal temperature between hot/cold.

The patent document CN 110342108 discloses a device for transporting foodstuffs, not being able, however, to transport hot food products. Furthermore, this device works with a temperature sensor (in order to avoid the decomposition temperature of the product to be transported).

The patent document CN208149996 discloses a device for transporting foodstuffs, not being able, however, to transport hot food products. In addition, this device works with a cold layer in the form of a “sandwich” (in order to avoid the decomposition temperature of the product to be transported).

The patent document U.S. Pat. No. 6,555,799 discloses a device that fulfills the same purpose of the subject matter of the invention, being only capable, however, of transporting hot food products with the use of re-sistances.

### OBJECTIVES OF THE INVENTION

One of the objectives of the present invention is to present a transport crate for transporting foodstuffs, capable of maintaining the temperature inside the crate, whether hot or cold, in order to keep the temperature of the transported foodstuff within a suitable range, depending on the type of foodstuff.

Another objective of the present invention is to propose a transport crate comprising thermally independent compartments.

It is another objective of the present invention to provide a transport crate with compartments that allow transporting different types of foodstuff, allowing different compartments to have different temperature ranges (hot/cold).

### SUMMARY OF THE INVENTION

The present invention refers to a transport crate for transporting foodstuff, capable of maintaining the temperature inside the crate and thus ensuring the integrity of the transported food.

The transport crate comprising a front access cover for filling/discharging said transport crate, at least two handles arranged at the rear part of said transport crate, pockets arranged on the right and/or left sides of said transport crate and a partition located at the rear part of the transport crate.

The interior of the transport crate comprises an internal structure, which includes at least one compartment for transporting foodstuff, and the at least one compartment formed in the internal structure of the transport crate is provided, on at least one of its surfaces, of a thermal exchange element, wherein the thermal exchange elements are Peltier thermoelectric plates and are associated with a mobile power source. The compartments are independently thermally insulated from each other. The compartments are configured so that they are independently controlled for their hot/cold temperatures.

The Peltier plates are activated by an activation button that independently selects the heating or cooling temperature option to be maintained inside each of the compartments.

### BRIEF DESCRIPTION OF THE DRAWINGS

The present invention will be described below in more detail, with reference to the attached drawings, wherein:

FIG. 1 shows a rear perspective view of the transport crate of the present invention with the front access cover open.

FIG. 2 shows a second rear perspective view of the transport crate of the present invention, showing the partition that accommodates the power source.

FIG. 3A shows a perspective view of the transport crate of the present invention, according to a first embodiment.

FIG. 3B shows a front view of the transport crate of the present invention, according to a first embodiment.

FIG. 4A shows a perspective view of the transport crate of the present invention, according to a second embodiment of the present invention.

FIG. 4B shows a front view of the transport crate of the present invention, according to a second embodiment of the present invention.

FIG. 5A shows a perspective view of the transport crate of the present invention, according to a third embodiment of the present invention.

FIG. 5B shows a front view of the transport crate of the present invention, according to a third embodiment of the present invention.

### DETAILED DESCRIPTION OF THE INVENTION

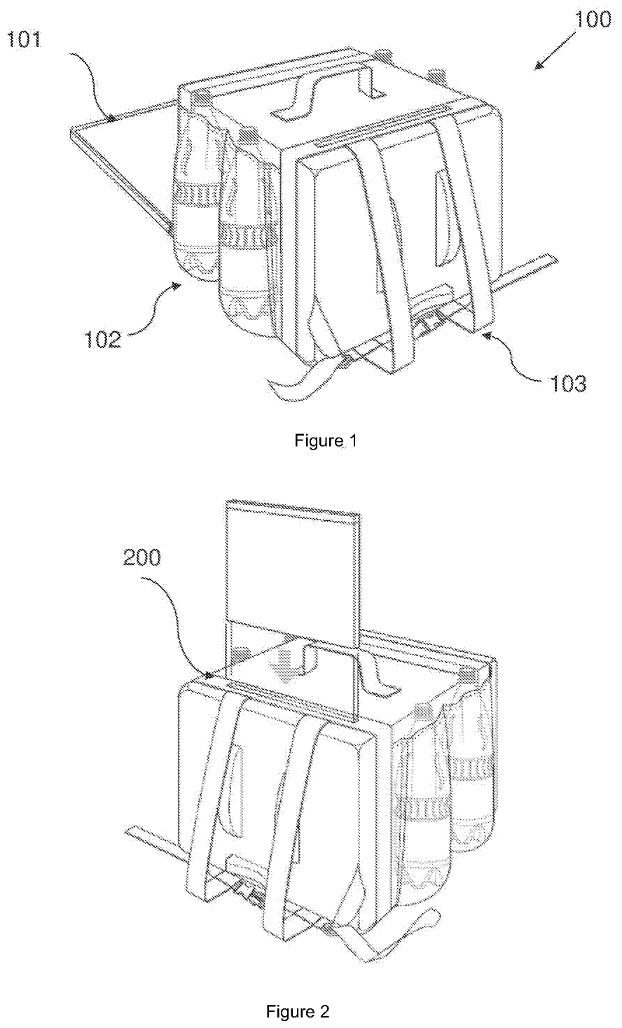

The present invention will be described below, based on FIGs. 1 to 5 previously presented.

The present invention achieves the objectives mentioned above by means of a transport crate 100 for transporting foodstuffs, capable of maintaining temperature inside the crate and thus ensuring the integrity of the transported food.

The transport crate 100, as shown in FIG. 1, comprises a front access cover 101 for filling/discharging foodstuffs. The transport crate 100 further comprises pockets 102 arranged at least on one side of the transport crate 100 for transporting, for example, cans, bottles or beverage containers. For this purpose, the pockets 102 have an interior partially covered with thermally insulating material, in order to reduce thermal exchanges and make the beverage containers suffer less impacts from thermal variation. The transport crate 100 is also provided with at least two handles 103 so that the crate can be carried on the user's back.

The interior of the transport crate 100, as shown in any one of FIGS. 2 to 5, includes an internal structure 300 forming at least one compartment 301 for transporting foodstuff.

In this sense, compartments 301 work as a kind of “independent shelves”, on which foodstuff is supported for its transport. The compartments 301 comprise, in at least one of their internal surfaces, a thermal exchange element for maintaining a certain temperature range inside the compartment. Of course, other of the surfaces may also comprise a heat exchange element. The heat exchange element of the transport crate of the present invention can cool or heat, so that, depending on the activation performed, a cooling or heating function can be selected.

Thus, each compartment 301 is provided, on at least one of its lateral surfaces, with a thermal exchange element, which is preferably a Peltier thermoelectric plate.

The Peltier thermoelectric plate, as known from the prior art, promotes thermal exchange through a temperature gradient derived from two poles made of different materials and electrically charged. In this way, the Peltier thermoelectric plate, provided on at least one of the lateral surfaces of each compartment 301, allows a user to select between a cooling temperature and a heating temperature to compose the internal environment of compartment 301.

It should be noted that, in order to provide a simplified and cheap construction, without the need for electronic circuits and complex sensors, the compartments 301 do not have the possibility of being adjusted to a fixed temperature. In this way, it is possible, according to the transport crate of the present invention, to ensure that environments (compartments) are in a hot temperature range or else in a cold temperature range, in which such hot/cold schedules are sufficient to preserve different foodstuffs that must be delivered in different temperature ranges. Inside a crate according to the present invention with more than one compartment, it is therefore possible to carry foodstuffs that require different types of environments, such as, for example, pizzas, ice creams

The choice between heating and cooling is selected by means of an activation button (not shown in the drawings), which activates the Peltier plate configured to perform the heat exchange according to the chosen option.

In this way, if the foodstuff is hot, the user selects, through the activation button, the heating option and the environment inside the compartment will remain warm, in order to prevent the transported food from cooling down, guaranteeing its quality. The same process applies in case the user transports a cooled foodstuff.

The transport crate 100 further comprises a partition 200 arranged on the surface of the rear part thereof, shown by FIG. 2, used to accommodate a mobile power source. The mobile power source is preferably, but not limited to, a portable battery of the stick or skid type. The mobile power source is associated with the thermal exchange elements, in order to provide the necessary power for their functioning.

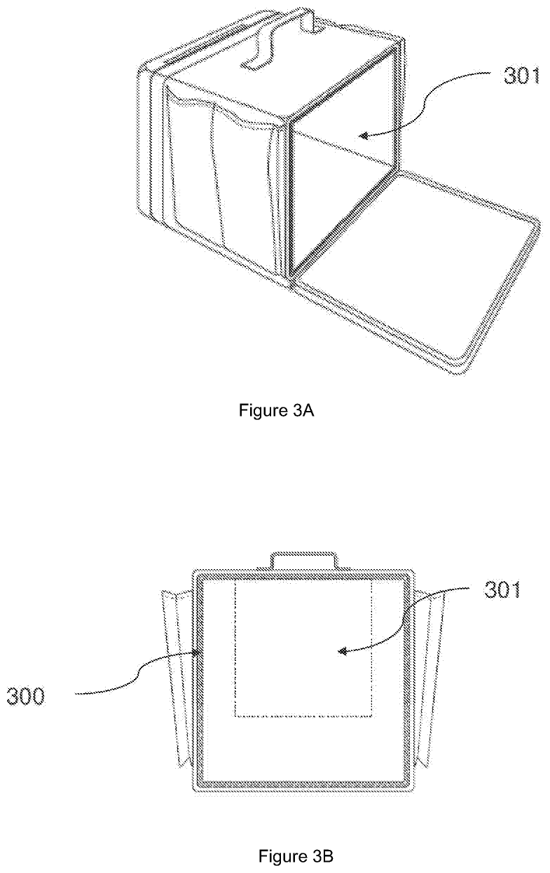

In one embodiment, as shown in FIGS. 3A and 3B, the interior of the transport crate 100 comprises a configuration in which its internal structure 300 comprises only one compartment.

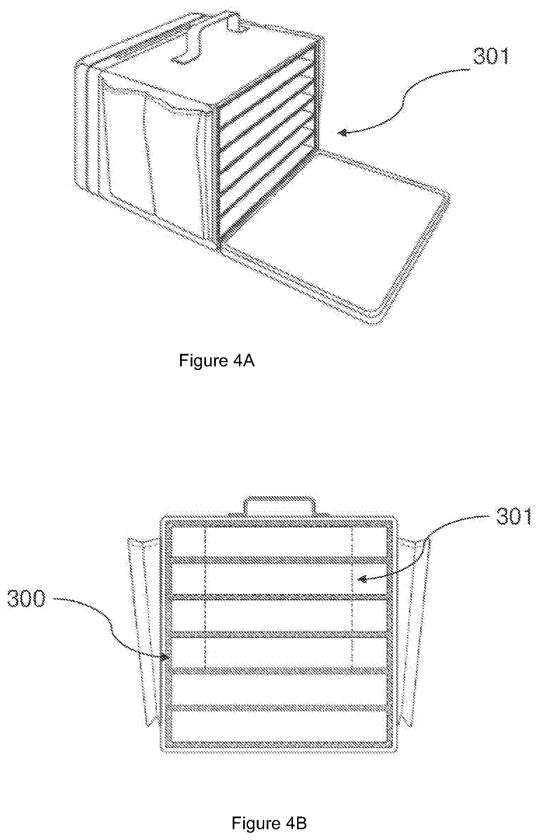

In another embodiment represented by FIGS. 4A and 4B, the transport crate 100 comprises a plurality of compartments 301 distributed parallel to each other. This type of configuration is mainly indicated for the simultaneous transport of many pizzas.

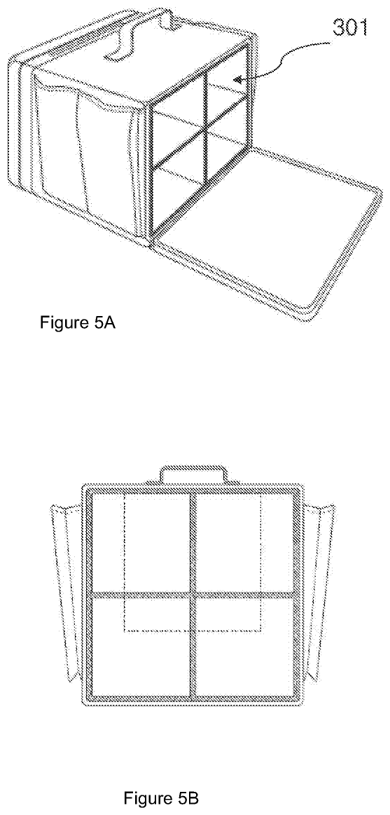

In yet another embodiment, as illustrated by FIGS. 5A and 5B, the transport crate 100 comprises four square compartments, ideal for transporting other types of foodstuff.

The transport crates according to the present invention can have an infinite distribution of compartments, varying their sizes, formats and quantities. Regardless of the characteristics of these compartments, all of them can be operated separately, making it possible to assign different functions between heating and cooling to each compartment.

The transport crate of the present invention will activate the compartments independently, according to which one was selected by the user and according to the desired function. In cases of disuse of any compartment, the button can simply turn it off to avoid unnecessary power consumption.

Having described an example of a preferred embodiment of the present invention, it should be understood that the scope of the present invention covers other possible variations of the described inventive concept, being limited only by the content of the claims, including the possible equivalents.

1. A transport crate for transporting foodstuffs, comprising:
a front access cover for filling/discharging said transport crate;
at least two handles arranged at the rear part of said transport crate;
pockets arranged on the right and/or left sides of said transport crate, the transport crate being characterized in that it includes
an internal structure forming at least one compartment for transporting foodstuffs, wherein the at least one compartment formed in the internal structure of the transport crate is provided, on at least one of its surfaces, with a heat exchange element,
wherein the heat exchange elements are associated with a mobile power source, and wherein the heat exchange elements are configured to heat or cool each of the compartments independently of each other.

2. The transport crate, according to claim 1,
characterized in that the heat exchange element is a Peltier thermoelectric plate.

3. The transport crate according to claim 1, characterized in that the internal structure, the rear wall of the transport crate and the access cover are coated with thermally insulating material.

4. The transport crate, according to claim 1, characterized in that, between the compartments, a thermally insulating material is inserted.

5. The transport crate according to claim 1, characterized in that it comprises a partition configured to accommodate said power source.

6. The transport crate, according to claim 1, characterized in that it comprises an activation button configured to actuate and control the heat exchange elements for one function among the cooling and heating functions.

7. The transport crate, according to claim 1, characterized in that the mobile power source is a portable battery.

8. The transport crate, according to claim 1, characterized in that the pockets comprised on each side of the transport crate have their internal spaces partially covered with thermally insulating material.
